(19) United States
(12) Patent Application Publication
(10) Pub. No.: US 2008/0077555 A1
(43) Pub. Date: Mar. 27, 2008

(54) VARIABLE DATA WORKFLOW SYSTEM AND METHOD

(76) Inventors: Frank W. Miller, Gulfport, FL (US); Edward-Lee Ford, St. Petersburg, FL (US)

Correspondence Address: BURNS & LEVINSON, LLP, 125 SUMMER STREET, BOSTON, MA, 02110, US

(21) Appl. No.: 11/859,221

(22) Filed: Sep. 21, 2007

Related U.S. Application Data
(60) Provisional application No. 60/846,438, filed on Sep. 22, 2006.

(51) Int. Cl. G06F 17/30

(52) U.S. Cl. 707/2; 707/E17.017

(57) ABSTRACT

The variable data workflow system and method of the present invention can provide a one:many relationship between input/variables and a plurality of different types of items produced by the system and method. The invention allows for the collection of data and further analysis of recipients, in particular for adding them to further campaigns.

### CROSS REFERENCE TO RELATED APPLICATIONS

This application claims priority under 35 U.S.C. § 119 from U.S. Provisional Patent Application Ser. No. 60/846,438 entitled VARIABLE DATA WORKFLOW SYSTEM AND METHOD, filed on Sep. 22, 2006.

### BACKGROUND

In a competitive commercial world, companies look for ways to distinguish their products and services from their competitors' products and services. In general, organizations look for unique ways to get the attention of their audiences through informational communications such as advertising, public service, or other announcements. One such way is to personalize and target the providing of information about products and services. An example of personalized communication is a magazine selling tools by mail that could include a personalized cover. An example of targeted communication is mailing that same magazine to a mailing list constructed from knowledge about the preferences of people on the mailing list.

Traditional variable data systems produce pieces that are each personalized while sharing a common structure and content with other pieces. For example, a variable data system of the prior art could receive input such as names and other text, associate the input with an item such as a cup, associate the item with formula (s) such as an equation that determines where on the cup to position the input, and create pieces based on the processing that occurs with respect to the item based on the input and the formula (s). The common structure and content can be reusable elements or single use elements.

A problem with traditional variable data systems is that there is a one:one relationship between personalization/positioning/targeting and the produced piece so that, for example, to place the personalization on cups and then later on T-shirts and target the same audience would require the process to be executed entirely from scratch twice. A further problem with traditional variable data systems is that they cannot be managed by a typical computer user because there are not appropriate security and approval mechanisms integrated into the variable data systems of the prior art. Still further problems with traditional variable data systems are that there is no user-controlled modification of variables such as, for example, formulas, images, text inputs, distortion matrices, graphs/charts, and direct type/direct smile, nor linking between variables to allow modifications of variables to be proliferated throughout the variables for a particular job.

What is needed is a system that allows a one:many relationship between personalization/positioning/targeting and the produced piece(s). What is further needed is a system that can be managed by a typical computer user. What is still further needed is a system that allows user-controlled modification of variables and linking between variables. Methods of use of these systems are also needed.

### SUMMARY

The variable data workflow system and method of the present invention augment traditional variable data systems by (1) providing for a one:many relationship between input/variables, such as formulas, and items, (2) providing for many types of variables, formulas being only one, (3) providing for relating the variables to each other, (4) allowing the user to control the variables, and (5) allowing the user to select a format in which the information is to be saved. In this way, a user may provide input and select variables, both of which can be used to create an infinite number of different types of pieces. The system can also include a user authenticator that can enable user control of selections in the workflow process. Thus, the variable data workflow system can include, but is not limited to, a client-enabled tool that allows the client to participate in the variable data work flow and use a single data model to create an infinite number of pieces.

The variable data workflow method can include the steps of building a data model for a company, collecting data to populate a database including the data model, where the database supports data reuse, selecting a data model, an information template, at least one variable associated with the information template, at least one variable position associated with at least one variable and the information template, and an imposition associated with the information template, applying the data model and variables to the information template to create an item, creating informational pieces from the item, the data model, feedback from previous mailings during the campaign, and a mapping between the data model and the variables, mailing the informational pieces to recipients on a mailing list derived from the data model, receiving feedback with respect to the informational piece, modifying the data model (and thus potentially modifying, for example, the mailing list and informational piece) based on the feedback, and mailing the potentially modified informational pieces to recipients on a potentially modified mailing list based on the modified data model. Optionally, the variable data workflow method can include the step of determining customer feedback to provide input data for conventional Customer Relationship Management (CRM) systems. An imposition is used to simplify output to, for example, a printer or an e-mail file.

For a better understanding of the present invention, together with other and further objects thereof, reference is made to the accompanying drawings and detailed description.

### DESCRIPTION OF THE SEVERAL VIEWS OF THE DRAWING

FIG. 1 is a schematic block diagram of an illustrative embodiment of the system of the present invention can execute;

FIG. 2 is a schematic block diagram of an illustrative embodiment of further details of the system of the present invention; and

FIG. 3 is a flowchart of an illustrative embodiment of the method of the present invention.

### DETAILED DESCRIPTION

Embodiments according to the present teachings are now described more fully hereinafter with reference to the accompanying drawings. The following configuration description is presented for illustrative purposes only.

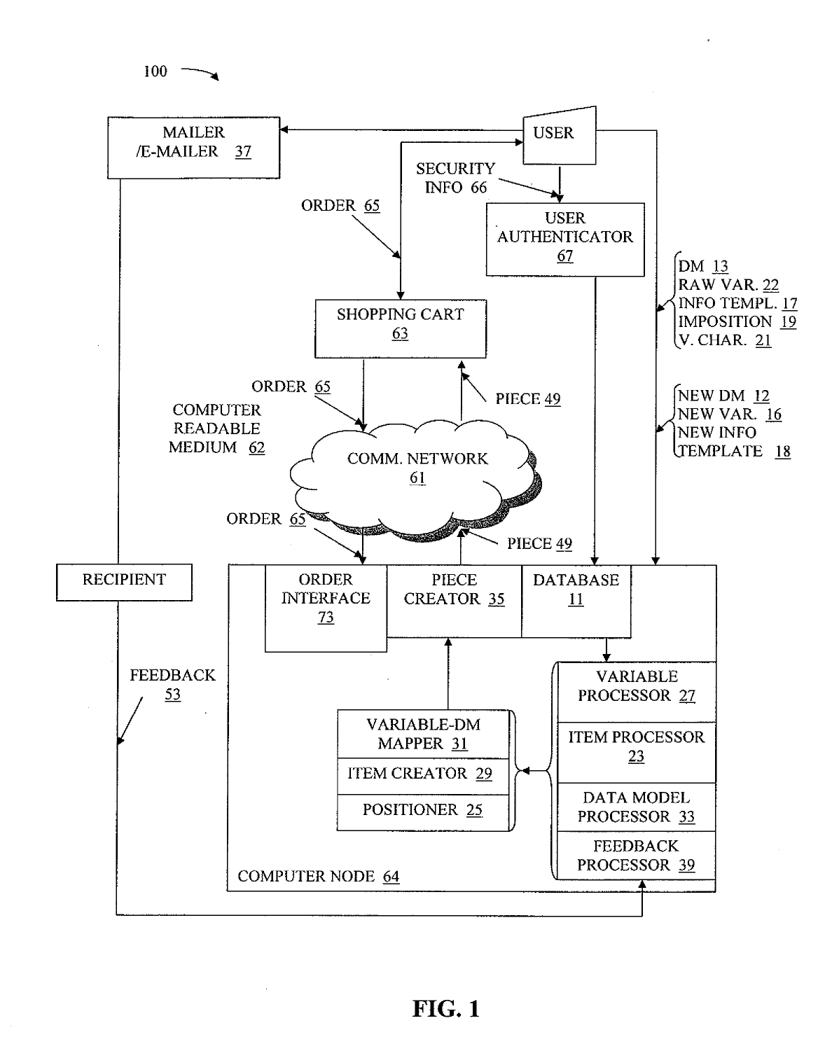

Referring now to FIG. 1, the environment in which system 100 executes can include, but is not limited to, communications network 61 for allowing the user to place order 65 for informational pieces 49 by use of shopping cart 63. The user could map a mailing list that is part of data model 13 to order 65, system 100 could receive data from a data collection method such as, for example, phone, internet, or manual entry, and if mapping has occurred, could apply these data to the next mailing/emailing in the informational campaign. This method of user access to informational pieces 49 is illustrative and can be modified within the scope of the present invention.

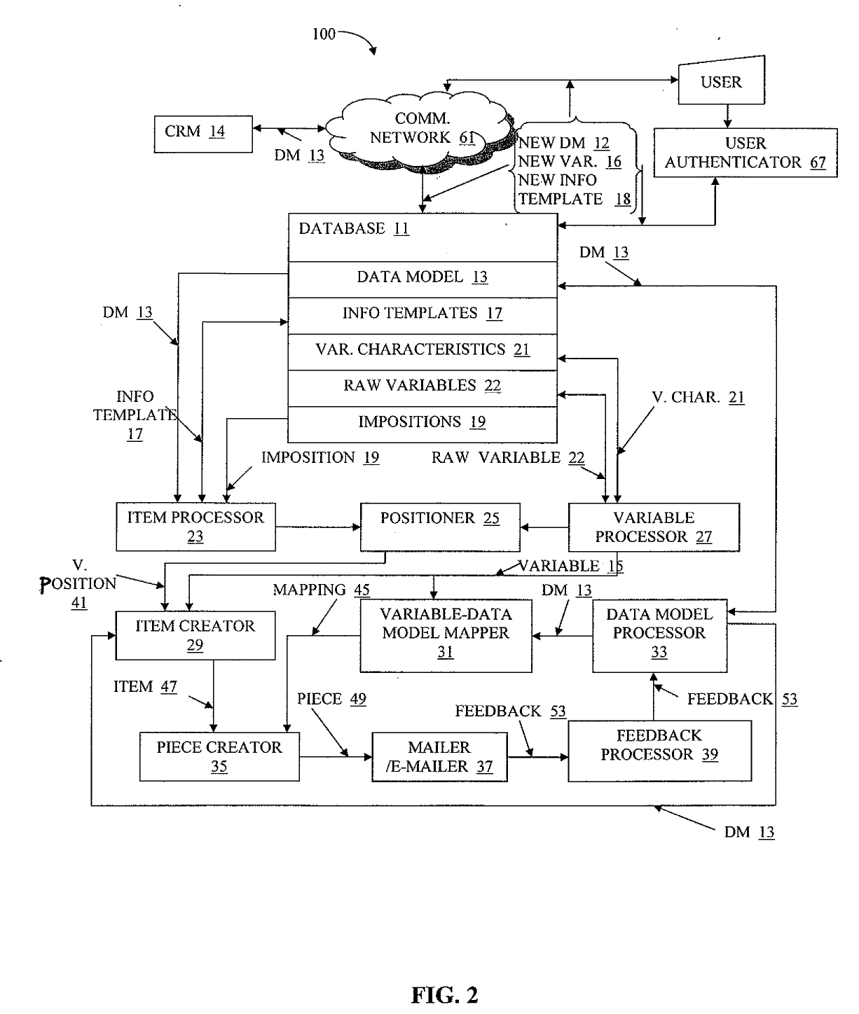

Referring now to FIGS. 1 and 2, system 100 can include, but is not limited to, user authenticator 67 which allows users to have access to certain preselected parts of system 100. For example, a system administrator could normally have access to raw variables 22, and could have flexibility in modifying raw variables 22. The user, on the other hand, could have access to created items 47 and data model 13 in order to create informational pieces 49. System 100 can also include database 11 which can include, but is not limited to, data models 13, information templates 17, raw variables 22, variable characteristics 21, and impositions 19. Data models 13 can be schema that incorporate information about a company, some of which can be mapped to informational pieces 49, as illustrated above. New data models 12 can be added, and existing data models 13 can be deleted or modified, with the appropriate user authentication. A unified company-based data model 13, as opposed to an item-based data model of the prior art, can allow continuity of data that enables a user to transfer informational pieces 49 between mailing lists to accommodate an automated information campaign and further integration into conventional CRM 14 applications. CRM 14 can encompass the capabilities, methodologies, and technologies that support an enterprise in managing customer relationships. The general purpose of CRM 14 is to enable organizations to better manage their audience through the introduction of reliable systems, processes and procedures. CRM 14 can include, but is not limited to, functions such as identifying audience success factors, creating an audience-based culture, adopting audience-based measures, developing an end-to-end process to serve an audience, recommending problem responses, recommending complaint responses, and tracking all aspects of providing information to an existing and prospective audience as well as providing user support.

Data model processor 33, can accept and incorporate changes to data model 13 such that, for example, a corporate mailing list could be changed during an informational campaign in order to accommodate feedback 53 received from a previous mailing during the informational campaign, and appropriate action can be taken for those that need to be moved to CRM 14 or dropped.

Information templates 17 can be a plurality of different types of informational items such as, for example, T-shirts and cups, or transactional items such as statements, or text books that can be used to provide information. Information templates 17 become the basis for creating a plurality of different types of items 47, which are used to create informational pieces 49. Further, system 100 can include categories to house and sort information templates 17. Categories can also be used to partition information templates so that user authentication is required before a category can be accessed. New information templates 18 can be added to system 100. Information templates 17 can have many attributes, at least two of which are relevant to a print-on-demand type system: fulfillment, which allows usage of information template 17 to be tracked, and print-on-demand setting which allows an output format for each of the plurality of different items 47 to be selected. Fulfillment and print-on-demand settings allow both the use of pre-printed shells that can be used for item imprint, and also for a printer, a receiver of the file, to track the plurality of different items 47 as they are processed by system 100. Print-on-demand settings can allow selection of a printer, e-mail format such as, for example, HTML, and imposition 19, the layout, scale, and typography attributes of the plurality of different items 47. In the illustrative embodiment, piece creator 35 can convert data uploads/selections to a gzipped array in order to manage data handling and transfer between mailing lists within system 100, or to provide for export to another file structure. After a user has placed item 47 in shopping cart 63, when order interface 73 reviews order 65, data model processor 33 can allow the user to view/edit/download and use mailing lists according to the user's security information 66 and the selected data model 13. Data model processor 33 can also allow the user to create a mailing list from a conventional contact manager system using the capabilities provided in the conventional contact manager system such as, for example, search. Data model processor 33 can further allow the user to access a file that can be made private and can include a counts list, touch data, and name/address data. Data model processor 33 can also provide for purchasing a mailing list from a mailing list vendor typically from a vendor's website.

Continuing to refer to FIGS. 1 and 2, raw variables 22 can be, for example, formulas, text inputs, images, distortion matrices, graphs/charts, and direct type/direct smile, and can be, for example, daisy-chained to one another to create loops and sequential data. Raw variables 22 can be named, can be associated with a description, can be displayed after variable processing is complete, and can be assigned an output filter which can be, for example, an expression applied to variable 15 before variable 15 is used to create informational piece 49. Raw variables 22 such as formulas can be saved for later use by other workflows.

Examples of formula and text variables follow:

Formulas:

Threshold:

The threshold formula type applies variables across a numeric matrix, and possibly makes the result available to another variable.

| Var_name | min | max | output |
|---|---|---|---|
| [[FAMILY_SIZE]] | 1 | 2 | no_kids |
| [[FAMILY_SIZE]] | 3 | 99 | kids |

Equation:

The equation formula type provides for variables to be assembled into equations, and the result possibly made available to other variables.
[[MONTHLY_INCOME]]−[[TOTAL_DEBT]]=[[DTI]]
Text Variable:

This text variable formula type assembles variables and text together, and can send the assembly to another variable. The text variable can be, for example, an address block of a direct mail piece:

[[COMPANY]]<br>

[[CONTACT]]<br>

[[ADDRESS1]]<br>

[[ADDRESS2]] (<br>)

[[CITY]], [[STATE]] [[ZIPCODE]]

With respect to image variables, in the illustrative embodiment, images can be associated with keywords that can be assigned, for example, manually, to images. The plurality of different items 47 that reference keywords that are associated with multiple images can use a random selection process to choose a single image to be placed upon informational piece 49. A default image can be assigned to each keyword so that if no matches are found for a certain keyword, the default image can be chosen. In the illustrative embodiment, a digital asset manager can track the attributes of the file, such as, for example, size, dots/inch, and color space, and an asset manager folder can be used to segment raw variable 22 so as to restrict image selection and assist with organization of company data. After categories (described above) are selected, one or more keywords can be assigned to each image. A “default” designation can be assigned to informational piece 49 or the same keyword can be applied to images randomly. Image output can be sent to a distortion matrix that can map the selected image onto, for example, a mug or a skewed, rotated item, and then used on informational piece 49.

With respect to graphs and charts, system 100 can provide dynamic charting capability because data model 13 can be modified while an informational campaign is in progress, and variable-data model mapper 31 can access updated data model 13. In the illustrative embodiment, charts and graphs can contain, but are not limited to containing, full color output (CMYK or spot), gradients, transparency, vector output, and web/HTML and print-on-demand output. Possible charts can be, but are not limited to being, 3d and flat bar and pie charts, and a line graph for scalable vector graphics, which can provide various formats as output including, but not limited to, PPML, Postscript, and JPG/GIF.

With respect to direct type/direct smile, variable processor 27 can provide output from variables 15 to a conventional direct type/direct smile application which returns a formatted file, for example, in a TIF format, which variable processor 27 can convert into, for example, JPEG, which can be included in an HTML document for, for example, e-mail. Variable processor 27 can provide direct type/direct smile application output to a deformation matrix to achieve further targeted information dissemination objectives.

Continuing to refer to FIGS. 1 and 2, raw variable 22 can be changed, for example, either automatically or manually, and system 100 uses a cascading methodology to proliferate raw variable 22 changes to related raw variables 22. Further, raw variables 22 can be mapped to each other so that any changes to a first raw variable 22 can be reflected in a second (third, fourth, . . . ) raw variable 22 that is (are) mapped to the first raw variable 22. After a first raw variable 22 is mapped to a second raw variable 22, for example, the first raw variable 22 can be evaluated back until a null data string is available or until it evaluates to an actual value. This is recursive for each raw variable 22, for example, each formula is mapped back and then stored, so that after it is executed, it does not need to be rerun. Still further, an unlimited number of instances of raw variables 22 and raw variable combinations can be created. Even further, the display of variable 15, after variable processor 27 completes whatever computations are necessary based on database 11, allows system 100 to collect data without having to position the data, which enables more rapid piece creation. System 100 enables variable characteristics 21 to be set such that raw variables 22 can include certain data when entering variable processor 27. Finally, new variables 16 can be added to system 100.

With still further reference to FIGS. 1 and 2, item processor 23 can accommodate changes to information templates 17 in database 11. In the illustrative embodiment, a system administrator could supply security information 66 (FIG. 1) sufficient to make changes in, for example, information templates 17, while a user could supply security information 66 sufficient to apply database 11 changes to items 47. Item processor 23 can subject certain data to output filters, for example:

Phone number formatting: (XXX)-XXX-XXX

All Caps: XXXXXXX

Extensions: (XXX)-XXX-XXXX ext. XXX

Referring still further to FIGS. 1 and 2, variable-data model mapper 31 can access information related to selected and processed variables 15 from a selected data model 13 and provide the information to the selected and processed variables 15 so that the variables, such as formulas, may be executed. The results of formula execution, item creation by item creator 29, and data positioning by positioner 25 are fed to piece creator 35 which accesses the selected data model 13 to create the Variable Data Publishing (VDP) informational pieces 49 appropriate for the particular phase of the informational campaign. During the informational campaign, feedback processor 39 could provide feedback 53 to the selected data model 13 in order to modify, for example, the mailing list to which mailer/e-mailer 37 would provide informational pieces 49, by, for example, print medium or a file, such as an HTML-formatted file, and could assign points to a recipient.

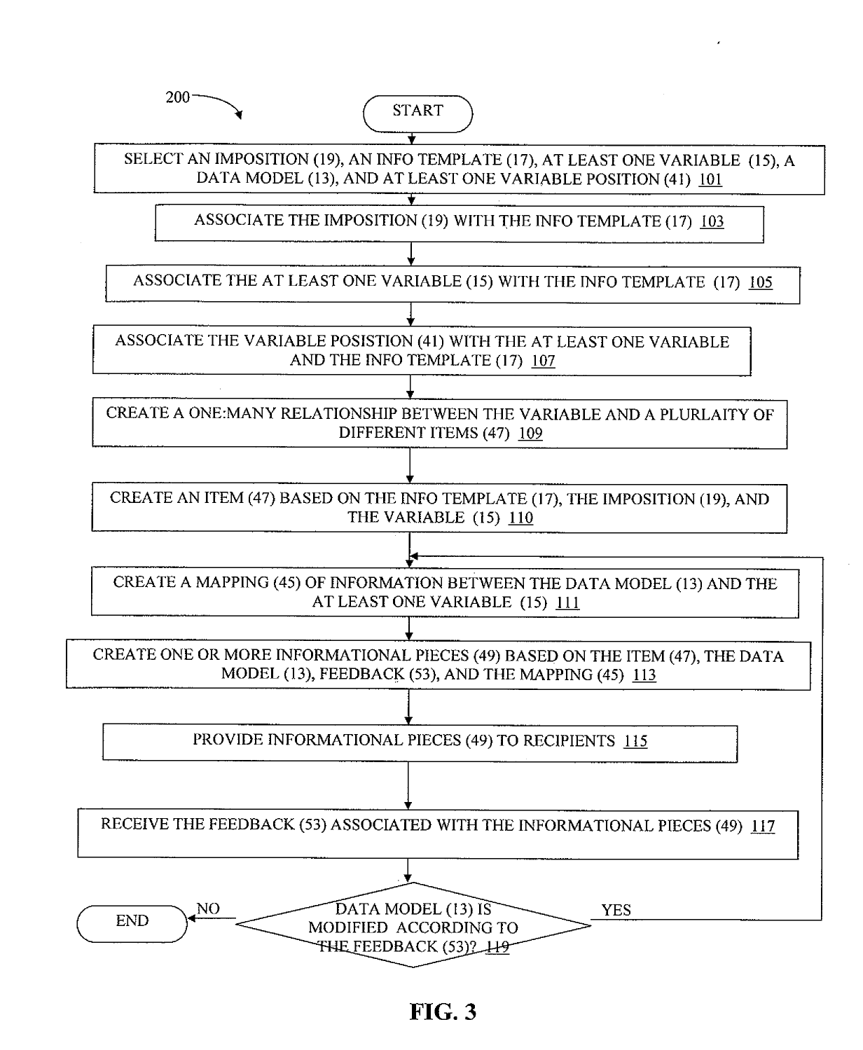

Referring now primarily to FIG. 3, method 200 for creating informational pieces 49 (FIG. 2) can include, but is not limited to, the steps of selecting 101 a data model 13, an imposition 19 (FIG. 2), an information template 17 (FIG. 2), a variable 15 (FIG. 2), and a variable position 41 (FIG. 2) and associating 103 imposition 19 with information template 17. Method 200 can further include the steps of associating 105 variable 15 with information template 17, associating 107 variable position 41 with variable 15 and information template 17, creating 109 a one:many relationship between the at least one variable (15) and a plurality of different types of items (47); and creating 110 the plurality of different types of items 47 (FIG. 2) based on information template 17, imposition 19, and variable 15. Method 200 can still further include the steps of creating 111 mapping 45 (FIG. 2) of information between data model 13 and variable 15, creating 113 informational pieces 49 (FIG. 2) based on the plurality of different types of items 47, data model 13, feedback 53 (FIG. 2), and mapping 45, providing 115 informational pieces 49 to recipient, and receiving 117 feedback 53 from the recipients with respect to informational pieces 49, weighting the feedback 53, and mapping the feedback 53 to the at least one recipient. If data model 13 is modified 119 according to feedback 53, method 200 repeats the steps 111, 113, 115, 117, and 119. Otherwise, method 200 ends. Optionally, method 200 can include the steps of providing weighted points to modify feedback 53 and method step 117.

Referring to FIGS. 1 and 3, method 200 (FIG. 3) can be, in whole or in part, implemented electronically. Signals representing actions taken by elements of system 100 (FIG. 1) can travel over at least one communications network 61 (FIG. 1). Control and data information can be electronically executed and stored on at least one computer-readable medium 62 (FIG. 1). The system can be implemented to execute on at least one computer node 64 (FIG. 1) in at least one communications network 61. Common forms of at least one computer-readable medium 62 can include, for example, but are not limited to, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, or any other medium from which a computer can read.

Although the invention has been described with respect to various embodiments, it should be realized this invention is also capable of a wide variety of further and other embodiments.

What is claimed is:

1. A method for creating at least one informational piece comprising the steps of:
(a) selecting a data model, an imposition, an information template, at least one variable, and at least one variable position;
(b) associating the imposition with the information template;
(c) associating the at least one variable with the information template;
(d) associating the at least one variable position with the at least one variable and the information template;
(e) creating a one:many relationship between the at least one variable and a plurality of different types of items;
(f) creating the plurality of different types of items based on the information template, the imposition, and the at least one variable;
(g) creating a mapping of information between the data model and the at least one variable;
(h) creating informational pieces based on the plurality of different types of items, the data model, feedback, and the mapping;
(i) providing the informational pieces to at least one recipient;
(j) receiving the feedback from the at least one recipient with respect to the informational pieces, weighting the feedback, and mapping the feedback to the at least one recipient;
(k) if data model is modified according to the feedback, repeating steps (f) through (j).

2. The method of claim 1 further comprising the steps of:
accessing a database to determine the data model, the at least one variable, the at least one variable characteristic, the imposition, and the information template;
adding at least one new data model to the database;
adding at least one new variable to the database; and
adding at least one new information template to the database.

3. The method of claim 1 further comprising the step of:
selecting the information template from a group including a direct marketing piece, a brochure, and a catalog segment.

4. The method of claim 1 further comprising the step of:
previewing the plurality of different types of items.

5. The method of claim 1 further comprising the steps of:
modifying the data model;
modifying the at least one variable; and
modifying the plurality of different types of items.

6. The method of claim 1 further comprising the step of:
previewing the informational pieces.

7. The method of claim 1 further comprising the step of:
adding the informational pieces to an electronic shopping cart; and
placing an order for the informational pieces from the electronic shopping cart.

8. The method of claim 1 further comprising the step of:
selecting the at least one variable from a group including formulas, images, text, distortion matrices, graphs, charts, and direct type/direct smile.

9. The method of claim 1 further comprising the step of:
authenticating a user for access to the database.

10. A system for creating informational pieces comprising:
at least one data model;
an information template;
at least one variable;
a variable-data model mapper configured to relate information in said data model to said at least one variable;
an item creator configured to create a one:many relationship between the at least one variable and a plurality of different types of items; said item creator further configured to create said plurality of different items based on said information template, said at least one data model, and said at least one variable;
a piece creator configured to create said informational pieces based on said plurality of different items, said data model, and feedback; and
a feedback processor configured to receive said feedback concerning said informational pieces, wherein said feedback is configured to modify said data model and assign points to a recipient.

11. The system as in claim 10 further comprising:
a database including said data model, said at least one variable, and said at least one information template; and
a user authenticator configured to verify that a user is allowed to modify said database based on security information.

12. The system as in claim 10 further comprising:
a shopping cart configured to allow the user to place an order for said informational pieces.

13. The system as in claim 10 further comprising:
a variable processor configured to receive a selection of said at least one variable, said variable processor configured to modify said at least one variable, said variable processor configured to add at least one new variable.

14. The system as in claim 10 further comprising:
a data model processor configured to receive a selection of said data model, said data model processor configured to modify said data model, said data model processor configured to add a new data model.

15. The system as in claim 10 further comprising:
an item processor configured to receive a selection of said at least one information template, said item processor configured to modify said at least one information template, said item processor configured to add a new information template.

16. The system as in claim 10 further comprising:
a mailer configured to mail said informational pieces based on said data model.

17. A computer node in a communications network configured to carry out the method according to claim 1.

18. A communications network comprising at least one node for carrying out the method according to claim 1.

19. A carrier wave traveling over a computer network carrying information configured to cause a computer system in the communications network to practice the method of claim 1.

20. A computer readable medium having instructions embodied therein for the practice of the method of claim 1.
